(19) United States
(12) Patent Application Publication
(10) Pub. No.: US 2009/0310490 A1
(43) Pub. Date: Dec. 17, 2009

(54) Radio communication system

(75) Inventor: Masatoshi Sekine, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/453,717

(22) Filed: May 20, 2009

(30) Foreign Application Priority Data
Jun. 11, 2008 (JP) 2008-153054

(51) Int. Cl. H04W 28/02

(52) U.S. Cl. 370/238

(57) ABSTRACT

A radio communication system in which radio communication terminals can efficiently transmit and receive data with each other suppressing the amount of data held by each of them. Each radio communication terminal can calculate an average delivery delay time of deliver data based on the degree of proximity to an adjacent radio communication terminal and transmit data delivery path information containing this and, for each data delivery path information received from another radio communication terminal, calculate a total average delivery delay time for delivery to a destination radio communication terminal based on the average delivery delay time contained in the data delivery path information and the average delivery delay time calculated by itself and, in response to the arrival of a data delivery time, transmit deliver data toward the destination radio communication terminal via the delivery path associated with the smallest total average delivery delay time.

### BACKGROUND OF THE INVENTION

1. Field of the Invention

The present invention relates to a radio communication system including a plurality of radio communication terminals each implementing radio communication functions.

2. Description of the Related Art

In these years, attempts have been made to establish a so-called ad hoc network over which data is exchanged between terminals able to radio-communicate such as personal computers, PDAs, or mobile phones directly, not via a base station. Since a base station or an access point is unnecessary, the ad hoc network can be established inexpensively and is perceived as effective means for establishing a network within a limited area. However, with ad hoc networks of which radio communication terminals move over a wide area, there is the following problem: since radio communication terminals can move freely, the radio communication terminals may become far apart, in which case the link between the radio communication terminals is cut off. In particular, it is difficult to secure the reliability of bidirectional over multi-hop, end-to-end data communication between radio communication terminals.

For example, in the case that data is sent by a data sending method, the so-called Flooding, where data is randomly sent to each radio communication terminal present in a network, the reliability of data delivery is high, thus enabling end-to-end delivery. However, with the use of this method, there is a problem that the amounts of data held by radio communication terminals relaying data become enormous. Hence, methods which use information about paths between radio communication terminals to restrict radio communication terminals to relay data, thus suppressing the amounts of data held by the radio communication terminals are being tried. For example, R. Draves, J. Padhye, and B. Zill, “Routing in Multi-Radio, Multi-Hop Wireless Mesh Networks”, In MOBICOM, 2004 (Non-Patent Literature 1) discloses a metric technique for path control in a multi-hop wireless network which performs path control using as a metric a transmission time between two radio communication terminals until the transmission/reception of a packet finishes that depends on the packet loss rates of links, thereby improving communication performance.

### SUMMARY OF THE INVENTION

However, because the metric technique disclosed in Non-Patent Literature 1 basically assumes a premise that the radio communication terminals do not move, when a user carrying a radio communication terminal moves around a wide area such as a residential area, offices, or commercial facilities, the connection and cutoff of the wireless link occur frequently and the cutoff of the wireless link may last for a long time. In this case, data cannot be transmitted and received efficiently between the radio communication terminals.

The present invention has been made in view of the above problem, and an object thereof is to provide a radio communication system in which radio communication terminals can efficiently transmit and receive data with each other suppressing the amount of data held by each of them.

According to the present invention, there is provided a radio communication system including a plurality of radio communication terminals which can freely exchange deliver data with each other. Each of the radio communication terminals includes a proximity degree information processing unit that calculates an average delivery delay time for delivery to an adjacent radio communication terminal close to a radio communication terminal comprising this unit based on beacons transmitted by the adjacent radio communication terminal; a radio communication unit that transmits data delivery path information containing information where the average delivery delay time is associated with a delivery destination ID; a path information control unit that, for each data delivery path information received from a radio communication terminal other than a radio communication terminal comprising this unit, calculates a total average delivery delay time for delivery to a destination radio communication terminal based on the average delivery delay time contained in the data delivery path information and the average delivery delay time calculated by the proximity degree information processing unit; and a data processing unit that, in response to the arrival of a data delivery time, transmits deliver data held by itself toward the destination radio communication terminal according to the delivery destination ID associated with the smallest one of the total average delivery delay times.

### BRIEF EXPLANATION OF THE DRAWINGS

FIG. 1 is a configuration diagram showing the entire configuration of a radio communication system according to the present embodiment;

FIG. 2 is a block diagram showing the configuration of a radio communication terminal;

FIG. 3 is a time chart showing a relationship of a between-terminal distance and delivery delay time to elapsed time;

FIG. 4 shows an example of a link information table;

FIG. 5 is a diagram showing an example of the production of data delivery path information and transmission steps;

FIG. 6 is a diagram showing another example of the production of data delivery path information and transmission steps;

FIG. 7 is a diagram showing the delivery steps for deliver data;

FIG. 8 shows data delivery path information having data delivery path information added thereto;

FIG. 9 is a diagram showing a relationship between elapsed time and the transmission/reception of the data delivery path information; and

FIG. 10 is a diagram showing a relationship to elapsed time of a total average delivery delay time in the data delivery path information received from a radio communication terminal MA by a radio communication terminal MC and a total average delivery delay time in information about a data delivery path to the radio communication terminal MA that is held by the radio communication terminal MC.

### DETAILED DESCRIPTION OF THE PREFERRED EMBODIMENT

Embodiments of the present invention will be described in detail below with reference to the accompanying drawings.

### First Embodiment

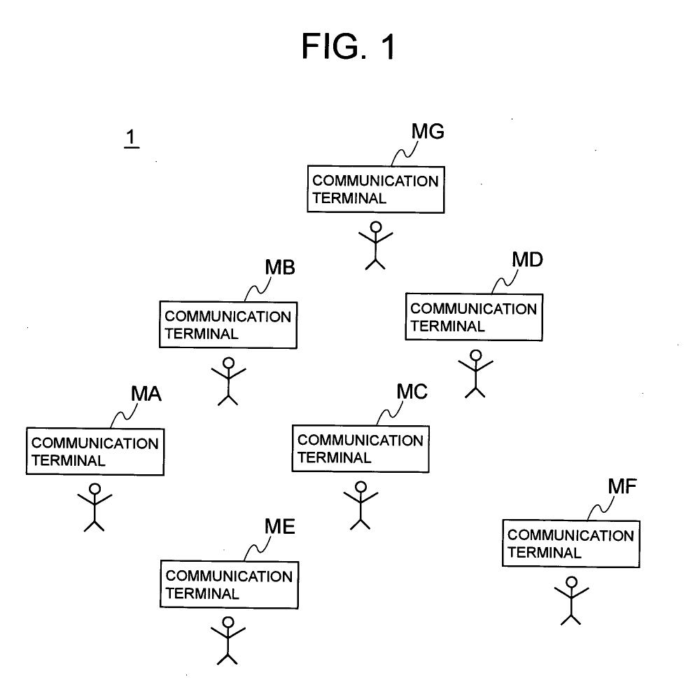

FIG. 1 is a configuration diagram showing the entire configuration of a radio communication system according to the present embodiment. Radio communication terminals MA to MG are each a terminal such as a mobile phone, a PDA, or a portable game terminal which can exchange data with an adjacent radio communication terminal and establish a so-called ad hoc network. The user of each of the radio communication terminals MA to MG carries it and moves around or stays in a place such as a residential area, an office, or commercial facilities.

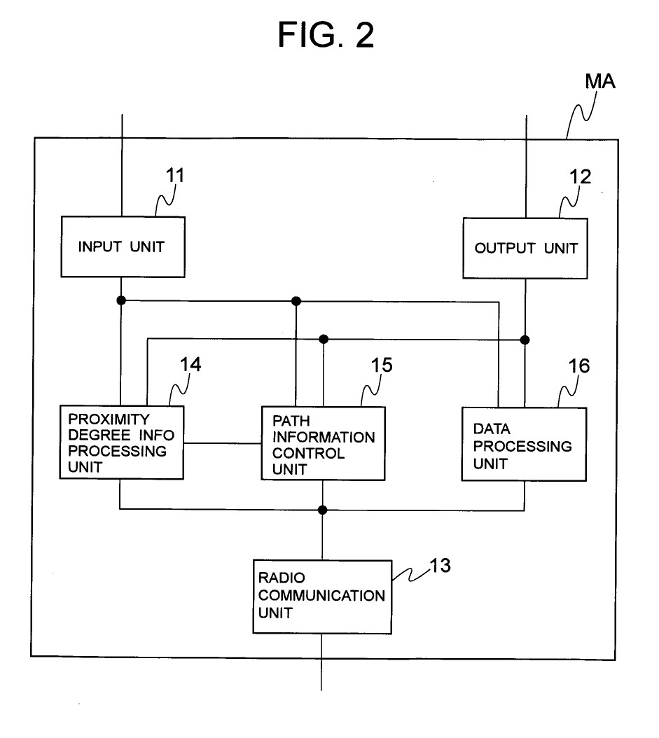

FIG. 2 is a block diagram showing the configuration of the radio communication terminal MA. The radio communication terminal MA comprises an input unit 11, an output unit 12, a radio communication unit 13, a proximity degree information processing unit 14, a path information control unit 15, and a data processing unit 16.

The input unit 11 is an input device to accept terminal operation input or data input from a user, such as a keyboard or input buttons.

The output unit 12 is an output device to output data processing results or other information to the user, such as a display or a speaker.

The radio communication unit 13 transmits and receives various signals, data, and data delivery path information to and from a radio communication terminal present within a radio communication-feasible range.

The proximity degree information processing unit 14 calculates and manages a terminal proximity degree for each of the radio communication terminals MB to MG based on signals received by the radio communication unit 13 (hereinafter called a proximity degree information process).

The path information control unit 15 produces and holds data delivery path information and controls the transmission of the data delivery path information to a radio communication terminal (hereinafter also called an adjacent radio communication terminal) close to the radio communication terminal MA comprising this unit (hereinafter called a delivery path information process).

The data processing unit 16 holds various data such as data to be delivered and delivers the deliver data to a radio communication terminal for which the data is destined (hereinafter also called a destination radio communication terminal) in response to the arrival of a data delivery time.

Also, each of the radio communication terminals MB to MG is the same in configuration as the radio communication terminal MA.

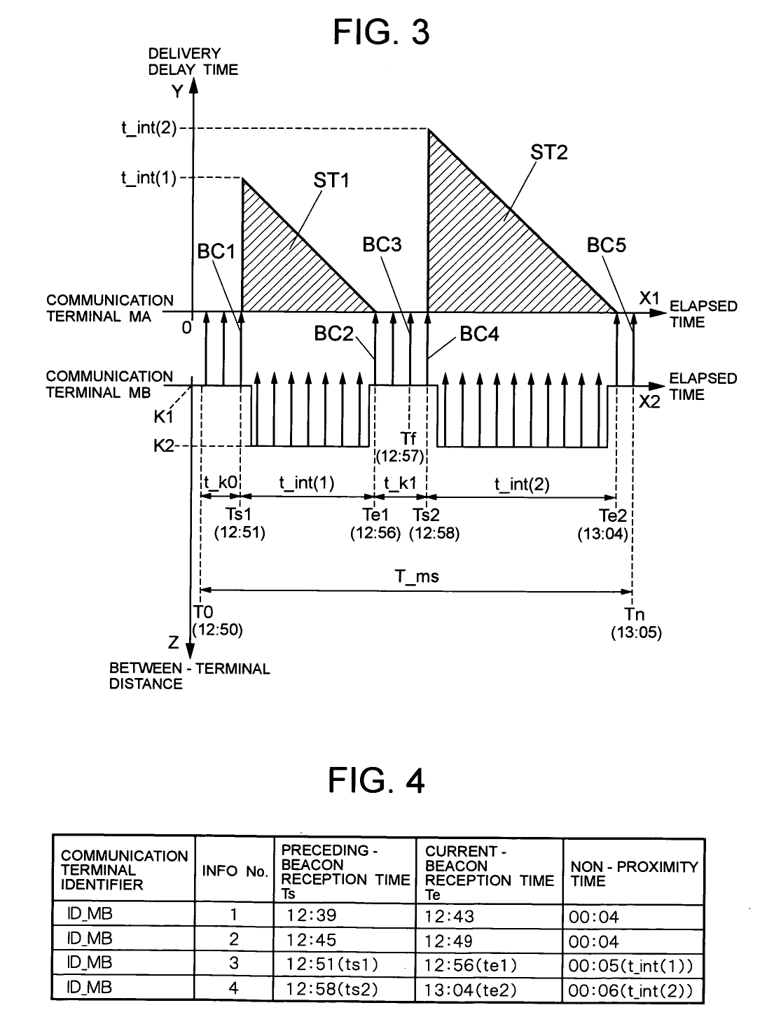

FIG. 3 is a time chart showing a relationship of a between-terminal distance and delivery delay time to elapsed time. FIG. 4 shows an example of a link information table. The proximity degree information process in the radio communication terminal MA will be described below with reference to FIGS. 3 and 4.

The radio communication unit 13 of the radio communication terminal MA transmits the terminal identifier ID_MA of the radio communication terminal MA periodically, for example, at one minute intervals by, e.g., a beacon and receives a beacon from each of the ones within a radio communication-feasible range of the radio communication terminals MB to MG.

In FIG. 3, upward arrows indicated by BC0, BC1, etc., represent the transmissions of a beacon from the radio communication terminal MB. The arrows whose tips are in contact with a horizontal axis X1 indicate a beacon signal reaching the radio communication terminal MA (i.e., the radio communication terminal MA receiving a beacon). In contrast, the arrows whose tips are not in contact with the horizontal axis X1 indicate a beacon signal not reaching the radio communication terminal MA (i.e., the radio communication terminal MA not receiving a beacon).

A vertical axis Z represents the distance between the radio communication terminals MA and MB (hereinafter called a between-terminal distance). When the between-terminal distance is at K1, the radio communication terminals MA and MB are close to each other, and the radio communication terminal MA receives a beacon from the radio communication terminal MB. In contrast, when the between-terminal distance is at K2, the radio communication terminals MA and MB are so apart that they cannot receive a beacon signal each other, and the radio communication terminal MA cannot receive a beacon from the radio communication terminal MB.

For the radio communication terminal MA, a proximity state is defined as the state where the interval of the reception of beacons from the radio communication terminal MB is less than a predetermined proximity threshold value Tth_n. For the radio communication terminal MA, a non-proximity state is defined as the state where the interval of the reception of beacons from the radio communication terminal MB is at or above the predetermined proximity threshold value Tth_n. The horizontal axes X1 and X2 represent time, and the radio communication terminals MA and MB are in the proximity state during proximity times t_k0 and t_k1 and in the non-proximity state during non-proximity times t_int(1) and t_int(2).

The proximity degree information processing unit 14 observes the times that the radio communication unit 13 receives a beacon from each radio communication terminal and creates and updates the link information table as shown in FIG. 4 by the process below. FIG. 4 shows the link information table for the radio communication terminal MB that is held by the proximity degree information processing unit 14 of the radio communication terminal MA. Each time the radio communication unit 13 has received a beacon from the radio communication terminal MB, if determining that the interval between the reception time Ts of that beacon (hereinafter called the current beacon) and the reception time Te that the radio communication unit 13 received the beacon preceding that beacon (hereinafter called the preceding beacon) is at or above the predetermined proximity threshold value Tth_n, the proximity degree information processing unit 14 records the reception time Ts, the reception time Te, and a non-proximity time t_int that is the difference between them into the link information table. Here, the proximity threshold value Tth_n is, e.g., equal to three minutes.

For example, where the reception time Te1 of a beacon BC2 is 12:56 and the reception time Ts1 of a beacon BC1 received preceding the beacon BC2 is 12:51 as shown in FIG. 3, the difference of five minutes between these two times is at or above the proximity threshold value Tth_n of three minutes, and hence the proximity degree information processing unit 14 records the beacon BC2 reception time Te1 of 12:56 as a current-beacon reception time Te1, the beacon BC1 reception time Ts1 of 12:51 as a preceding-beacon reception time Ts1, and the difference of five minutes between these two times as a non-proximity time t_int(1) into the link information table (the row marked with Information No. 3 in FIG. 4).

Further, for example, where the reception time Ts2 of a beacon BC4 is 12:58 and the reception time Tf of a beacon BC3 is 12:57 as shown in FIG. 3, the difference of one minute between these two times is less than the proximity threshold value Tth_n of three minutes, and hence the proximity degree information processing unit 14 does not record the beacon BC4 reception time Ts2 of 12:58, the beacon BC3 reception time Tf of 12:57, and the difference of one minute between these two times into the link information table. In this way, the proximity degree information processing unit 14 creates the link information table as shown in FIG. 4.

The proximity degree information processing unit 14 calculates an average delivery delay time T_ave based on information of the link information table. The average delivery delay time T_ave is the average of delivery delay times until radio communication terminals currently in the non-proximity state go mutually into the proximity state where data can be transmitted. The vertical axis Y of FIG. 3 represents the delivery delay time. The delivery delay times during proximity times t_k0 and t_k1 are zero. At time Ts1, the delivery delay time is equal to the non-proximity time t_int(1) and decreases over time and becomes zero at time Te1. Likewise, at time Ts2, the delivery delay time is equal to the non-proximity time t_int(2) and decreases over time and becomes zero at time Te2.

The proximity degree information processing unit 14, taking times when being in the non-proximity state in a time period from a reception time of a beacon back by a predetermined measurement time T_ms as non-proximity times t_int(n) (where n=1, 2, . . . , N and N is the number of non-proximity times in the measurement time T_ms), calculates the average delivery delay time T_ave. For example, in the case shown in FIG. 3, the proximity degree information processing unit 14 calculates the average delivery delay time T_ave using non-proximity times t_int(1) and t_int(2) in a time period of measurement time T_ms from a reception time Tn of a beacon BC5 back to time T0. In the example case of the link information table shown in FIG. 4, only the non-proximity times in the rows marked with Information Nos. 3 and 4 are used without using those in the rows marked with Information Nos. 1 and 2 in the calculation.

The average delivery delay time T_ave is the average of delivery delay times at the points in the measurement time T_ms and expressed as the equation (1):

[Expression 1]

$$T\_ave = \frac{1}{2} {\sum }_{n = 1}^{N} t\_int {( n )}^{2} / T\_ms \qquad ( 1 )$$

The equation (1) corresponds to the sum of the triangle areas ST1 and ST2 divided by the measurement time T_ms in the example case shown in FIG. 3. For example, assuming that the measurement time T_ms=15 minutes, it will be obtained that T_ave=½×(25+36)/15≅2 minutes in the example case of the link information table shown in FIG. 4.

When calculating the average delivery delay time T_ave, the proximity degree information processing unit 14 deletes information of preceding-beacon reception times, current-beacon reception times, and non-proximity times prior to the measurement time T_ms before the calculating time point (information in the rows marked with Information Nos. 1 and 2 in the example case of FIG. 4). In the same way as above, the proximity degree information processing unit 14 of the radio communication terminal MA calculates the average delivery delay time T_ave for each of the radio communication terminals MB to MG. Likewise, each of the radio communication terminals MB to MG calculates the average delivery delay time T_ave for each adjacent radio communication terminal.

The output unit 12 outputs the average delivery delay time T_ave obtained by the above process, and thereby the user can know the average delivery time for when delivering data directly to a specific radio communication terminal.

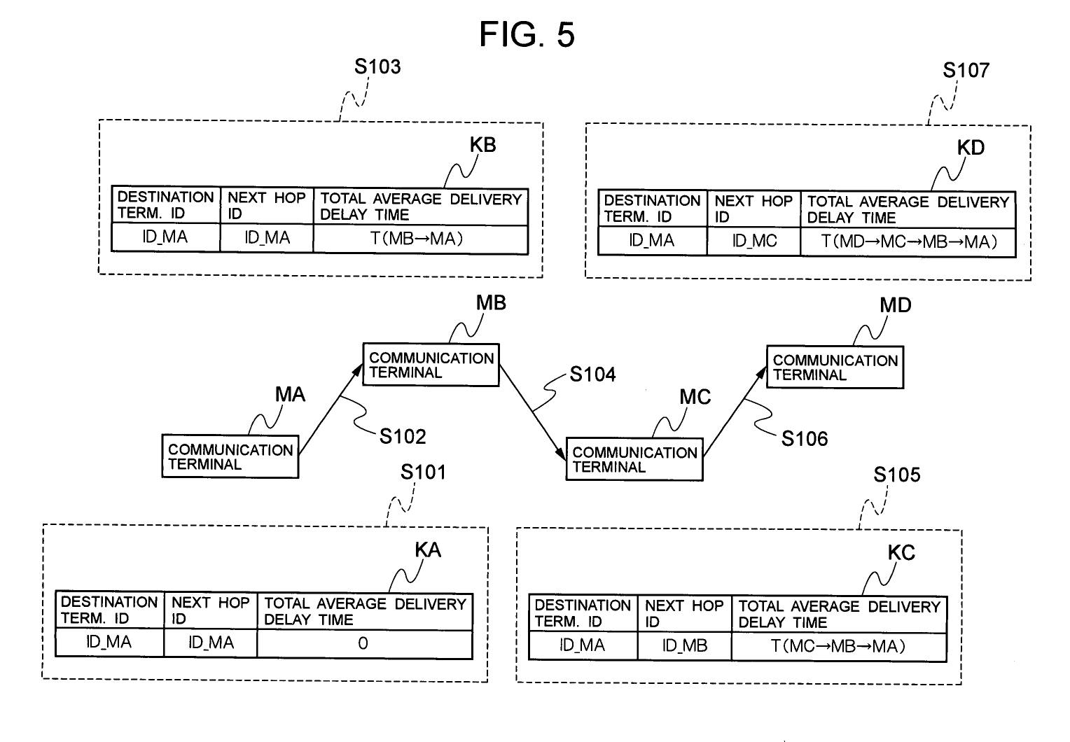

FIG. 5 is a diagram showing an example of the production of data delivery path information and transmission steps. The production of data delivery path information and a transmission process (delivery path information process) in each radio communication terminal when the radio communication terminal MA transmits information about a data delivery path to itself to a radio communication terminal present in the ad hoc network will be described below with reference to FIG. 5.

First, the path information control unit 15 of the radio communication terminal MA produces data delivery path information KA (step S101). In this step, the “destination terminal ID” is the terminal identifier of the radio communication terminal for which deliver data is destined (not the terminal identifier of the radio communication terminal for which the data delivery path information is destined). Here, it is the terminal identifier ID_MA of the radio communication terminal MA itself. The “next hop ID” is the terminal identifier of the radio communication terminal that is the next-hop destination in delivering the deliver data (not the terminal identifier of the radio communication terminal that is the next-hop destination for the data delivery path information) and is here the terminal identifier ID_MA of the radio communication terminal MA because the radio communication terminal MA itself is the radio communication terminal for which the deliver data is destined. The destination terminal ID and the next hop ID are, for example, the IP addresses of radio communication terminals and also called delivery destination IDs. The “total average delivery delay time” is the sum of the average delivery delay times T_ave of the radio communication terminals in the delivery path from this radio communication terminal having the data delivery path information to the radio communication terminal for which the deliver data is destined. Here, the total average delivery delay time is zero because the radio communication terminal MA itself is the radio communication terminal for which the deliver data is destined.

In response to the reception of a beacon by the radio communication unit 13, the path information control unit 15 transmits the data delivery path information. That is, the path information control unit 15 transmits the data delivery path information only when a radio communication terminal exists near the radio communication terminal MA. The path information control unit 15 observes the times that the radio communication unit 13 has received a beacon from each radio communication terminal and, when the reception interval of beacons from a radio communication terminal is at or above a predetermined transmission threshold value Tth_s, transmits the data delivery path information to that radio communication terminal.

Here, the path information control unit 15 of the radio communication terminal MA transmits the data delivery path information KA to the radio communication terminal MB (step S102). Instead of determining the timing of transmitting the data delivery path information by using the transmission threshold value Tth_s as described above, the path information control unit 15 may transmit the data delivery path information when updated and where another radio communication terminal is close to it. Further, instead of sending the data delivery path information alone, the path information control unit 15 may add it to a communication message or the like and transmit this. In order to limit the transmission range of the data delivery path information, the path information control unit 15 produces the data delivery path information containing a maximum allowable hop number and a lifetime. The radio communication terminal having received this data delivery path information discards data delivery path information that is over the maximum allowable hop number or the lifetime without transferring it. Further, the condition that points to transfer the data delivery path information to are restricted to radio communication terminals for which the average delivery delay time calculated from the equation (1) is less than a threshold value may be added.

The radio communication terminal MB having received the data delivery path information KA from the radio communication terminal MA produces data delivery path information KB (step S103). The path information control unit 15 of the radio communication terminal MB sets the “destination terminal ID” of the data delivery path information KB to ID_MA that is the same as the “destination terminal ID” of the data delivery path information KA. The path information control unit 15 sets the “next hop ID” of the data delivery path information KB to the terminal identifier ID_MA of the radio communication terminal MA that is the source of the data delivery path information KA. Further, the path information control unit 15 sets the “total average delivery delay time” of the data delivery path information KB to time T(MB→MA) that is the sum of the “total average delivery delay time” of 0 of the data delivery path information KA and average delivery time T(MB→MA) from the radio communication terminal MB to the radio communication terminal MA. The average delivery time T(MB→MA) is calculated by the aforementioned proximity degree information process by the proximity degree information processing unit 14 of the radio communication terminal MB. The path information control unit 15, holding the data delivery path information KB, has the radio communication unit 13 transmit the data delivery path information KB to the radio communication terminal MC (step S104).

The radio communication terminal MC having received the data delivery path information KB from the radio communication terminal MB produces data delivery path information KC (step S105). The path information control unit 15 of the radio communication terminal MC sets the “destination terminal ID” of the data delivery path information KC to ID MA that is the same as the “destination terminal ID” of the data delivery path information KB. The path information control unit 15 sets the “next hop ID” of the data delivery path information KC to the terminal identifier ID_MB of the radio communication terminal MB that is the source of the data delivery path information KB. Further, the path information control unit 15 sets the “total average delivery delay time” of the data delivery path information KC to time T(MC→MB→MA) that is the sum of the “total average delivery delay time” T(MB→MA) of the data delivery path information KB and average delivery time T(MC→MB) from the radio communication terminal MC to the radio communication terminal MB. The path information control unit 15, holding the data delivery path information KC, has the radio communication unit 13 transmit the data delivery path information KC to the radio communication terminal MD (step S106).

The radio communication terminal MD having received the data delivery path information KC from the radio communication terminal MC produces data delivery path information KD (step S107). In the same way as above, the path information control unit 15 of the radio communication terminal MD sets the “destination terminal ID” of the data delivery path information KD to ID_MA, the “next hop ID” to ID_MC, and the “total average delivery delay time” to T(MD→MC→MB→MA).

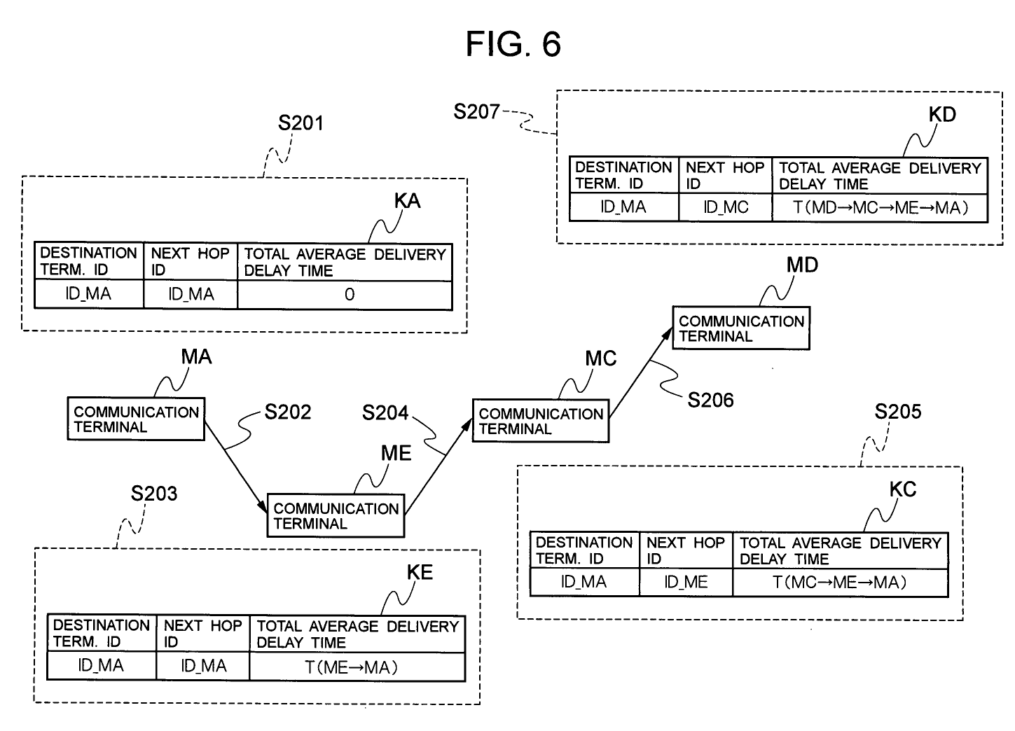

While the above example is an example case where the data delivery path information is transferred via the path of the radio communication terminals MA→MB→MC→MD, the data delivery path information may be transferred along a path other than this. FIG. 6 is a diagram showing an example of the production of data delivery path information and a transmission step in each radio communication terminal in a case where the data delivery path information is transferred along a path different from that of the above example. The production of data delivery path information and a transmission process in each radio communication terminal when the radio communication terminal MA transmits information about a data delivery path to itself to a radio communication terminal present in the ad hoc network will be described below with reference to FIG. 6.

The path information control unit 15 of the radio communication terminal MA produces the data delivery path information KA (step S201) and transmits this to the radio communication terminal ME (step S202). Note that the production of the data delivery path information and the transmission thereof are the same as in the example of FIG. 5.

The radio communication terminal ME having received the data delivery path information KA from the radio communication terminal MA produces data delivery path information KE (step S203). The path information control unit 15 of the radio communication terminal ME sets the “destination terminal ID” of the data delivery path information KE to ID_MA, the “next hop ID” to ID_MA, and the “total average delivery delay time” to T(ME→MA). The radio communication terminal ME, holding the data delivery path information KE, transmits this to the radio communication terminal MC (step S204).

The radio communication terminal MC having received the data delivery path information KE from the radio communication terminal ME produces data delivery path information KC (step S205). The path information control unit 15 of the radio communication terminal MC sets the “destination terminal ID” of the data delivery path information KC to ID_MA, the “next hop ID” to ID_ME, and the “total average delivery delay time” to T(MC→ME→MA). At this time point, the radio communication terminal MC has two pieces of data delivery path information KC, i.e., the data delivery path information KC produced based on the data delivery path information KE from the radio communication terminal ME and the data delivery path information KC produced based on the data delivery path information KB from the radio communication terminal MB as described in the example of FIG. 5. The radio communication terminal MC holds one of the two pieces of data delivery path information KC whose “total average delivery delay time” is smaller and discards the other. Here, the radio communication terminal MC holds the data delivery path information KC produced based on the data delivery path information KE from the radio communication terminal ME, transmitting this data delivery path information KC to the radio communication terminal MD (step S206).

The radio communication terminal MD having received the data delivery path information KC from the radio communication terminal MC produces data delivery path information KD (step S207). In the same way as above, the path information control unit 15 of the radio communication terminal MD sets the “destination terminal ID” of the data delivery path information KD to ID_MA, the “next hop ID” to ID_MC, and the “total average delivery delay time” to T(MD→MC→ME→MA).

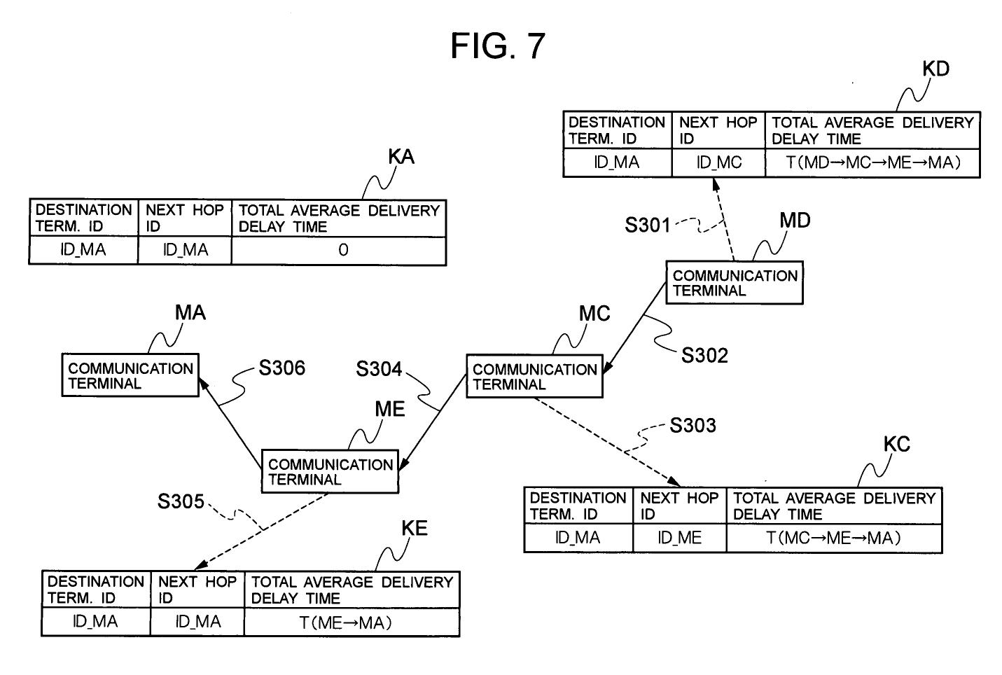

FIG. 7 is a diagram showing the delivery steps for deliver data. The data processing unit 16 of the radio communication terminal having received the data delivery path information, in response to the arrival of the data delivery time, refers to the “next hop ID” of the data delivery path information and transmits deliver data to the radio communication terminal corresponding to this “next hop ID” so as to deliver the deliver data to the destination radio communication terminal (the radio communication terminal corresponding to the “destination terminal ID” of the data delivery path information). For example, the data processing unit 16 of the radio communication terminal MD refers to the “next hop ID” of the data delivery path information KD possessed by itself (step S301) and transmits deliver data to the radio communication terminal MC corresponding to ID_MC (step S302). In the radio communication terminals MC and ME, the same process is performed, and thereby the deliver data reaches the radio communication terminal MA (steps S303 to S306).

As described above, in the radio communication system according to the present embodiment, each radio communication terminal produces the data delivery path information containing the destination terminal ID, the next hop ID, and the total average delivery delay time and, holding this, in response to the reception of a beacon from an adjacent radio communication terminal close to itself, transmits the data delivery path information to the adjacent radio communication terminal. The radio communication terminal transmits the data delivery path information only when another radio communication terminal exists near it. By this means redundant transmissions of the data delivery path information can be suppressed. In addition, when having received a plurality of data delivery path information via a plurality of different paths, the radio communication terminal holds data delivery path information whose total average delivery delay time is the smallest, transmitting this to an adjacent radio communication terminal. By this means, when delivering deliver data, the deliver data can be delivered to the destination radio communication terminal via the path whose total average delivery delay time is the smallest, and hence the delivery delay can be suppressed, thus enabling efficient transmission/reception of data. Further, because the radio communication terminal restricts points to transmit the data delivery path information to, to radio communication terminals close to itself, the amounts of data held by radio communication terminals relaying the data delivery path information can be suppressed as compared with other transmission techniques such as flooding.

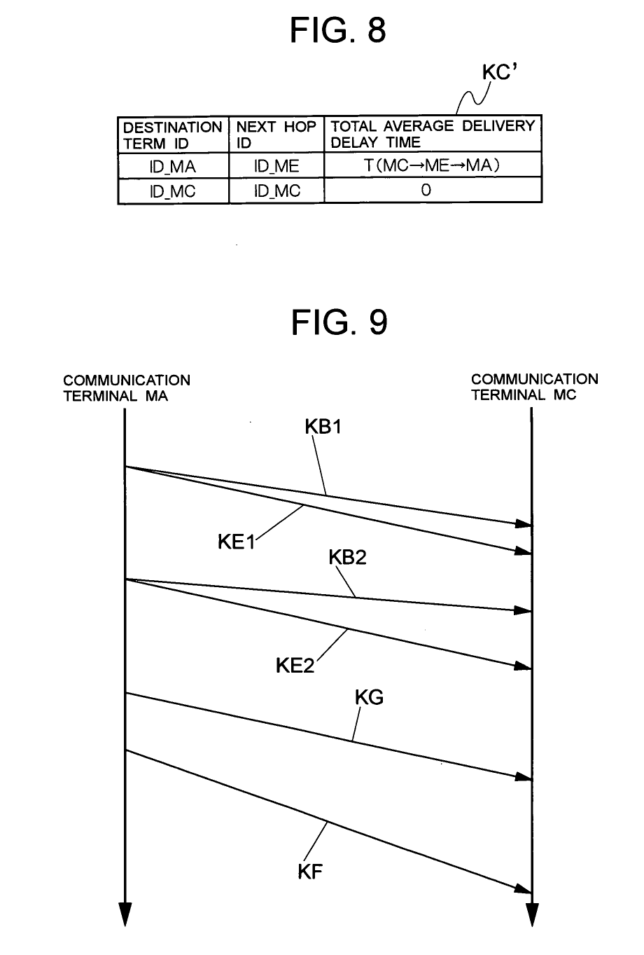

While the above example is an example of the transfer of the data delivery path information where the radio communication terminal MA is the destination of deliver data, the radio communication terminals MB, MC, MD, and ME in the transfer path for the data delivery path information may produce and transmit data delivery path information having added thereto information indicating that themselves are the destination of deliver data. For example, in step S205 of FIG. 6, the radio communication terminal MC may add information indicating that itself is the destination of deliver data, that is, information having ID_MC as the “destination terminal ID”, ID_MC as the “next hop ID”, and zero as the “total average delivery delay time” to produce data delivery path information KC′ as shown in FIG. 8.

### Second Embodiment

The block diagram of a second embodiment is the same as the block diagram (FIG. 2) of the first embodiment. Part in which it differs from the first embodiment will mainly be described below. In the second embodiment, control below is added to the updating of the data delivery path information in the path information control unit 15 of the block diagram of the first embodiment.

FIG. 9 is a diagram showing a relationship between elapsed time and the transmission/reception of the data delivery path information. As described in the first embodiment, the radio communication terminal MA transmits the data delivery path information each time a predetermined condition is satisfied such as the one that the reception interval of beacons from a radio communication terminal is at or above a predetermined transmission threshold value Tth_s. At this time, the radio communication terminal MC may receive a plurality of data delivery path information via a plurality of different paths. For example, there are data delivery path information KB1 and KB2 received via the radio communication terminal MB and data delivery path information KE1 and KE2 received via the radio communication terminal ME. The radio communication terminal MC receives the data delivery path information KB1, KB2, KE1, and KE2 at different times respectively. In the first embodiment, since the radio communication terminal MC holds data delivery path information whose total average delivery delay time is smaller, the “next hop ID” and “total average delivery delay time” of the held data delivery path information may change over time.

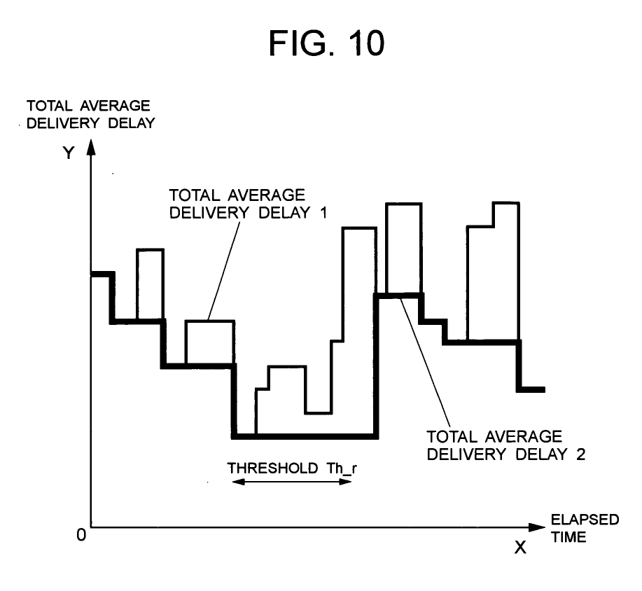

FIG. 10 is a diagram showing a relationship to elapsed time of the total average delivery delay time (hereinafter a total average delivery delay time 1) in the data delivery path information received from the radio communication terminal MA by the radio communication terminal MC and the total average delivery delay time (hereinafter a total average delivery delay time 2) in information about a data delivery path to the radio communication terminal MA that is held by the radio communication terminal MC. The horizontal axis X represents elapsed time, and the vertical axis Y represents the total average delivery delay time. Since the radio communication terminals MA and MC move, the total average delivery delay time 1 increases/decreases over time. In the case of the first embodiment, because the path having the smallest total average delivery delay time is selected, the data delivery path information is updated when the total average delivery delay time 1 is on a downward trend, thus the total average delivery delay time 2 decreases. In contrast, when the total average delivery delay time 1 is on an upward trend, the data delivery path information is not updated, and thus the total average delivery delay time 2 remains the smallest. In order to make the increase/decrease in the total average delivery delay time due to the movement of the radio communication terminals reflected therein, the data delivery path information is updated not only when having received data delivery path information having the smallest total average delivery delay time like in the first embodiment, but also as follows: if the data delivery path information for the radio communication terminal MA in the radio communication terminal MC has not been updated during a period of an update threshold value Th_r or longer as shown in FIG. 10, the path information control unit 15 updates the data delivery path information for the radio communication terminal MA in the radio communication terminal MC upon the reception of the next information about a data delivery path to the radio communication terminal MA.

This application is based on Japanese Patent Application No. 2008-153054 which is hereby incorporated by reference.

What is claimed is:

1. A radio communication system including a plurality of radio communication terminals which can freely exchange deliver data with each other, each of said plurality of radio communication terminals including:
a proximity degree information processing unit that calculates an average delivery delay time for delivery to an adjacent radio communication terminal close to a radio communication terminal comprising this unit based on beacons transmitted by said adjacent radio communication terminal;
a radio communication unit that transmits data delivery path information containing information where said average delivery delay time is associated with a delivery destination ID;
a path information control unit that, for each data delivery path information received from a radio communication terminal other than a radio communication terminal comprising this unit, calculates a total average delivery delay time for delivery to a destination radio communication terminal based on the average delivery delay time contained in the data delivery path information and the average delivery delay time calculated by said proximity degree information processing unit; and
a data processing unit that, in response to the arrival of a data delivery time, transmits deliver data held by itself toward said destination radio communication terminal according to the delivery destination ID associated with the smallest one of said total average delivery delay times.

2. A radio communication system according to claim 1, wherein said proximity degree information processing unit calculates said average delivery delay time based on non-proximity periods determined based on reception intervals of beacons from a radio communication terminal other than the radio communication terminal comprising this unit.

3. A radio communication system according to claim 1, wherein letting T_ms be a predetermined measurement time and t_int(n) (where n=1, 2, 3, . . . , N and N is the number of non-proximity periods in the predetermined measurement time) be non-proximity periods present in a time period from a reception time of said beacon back by said predetermined measurement time, said proximity degree information processing unit takes a value T_ave calculated from the following equation as said average delivery delay time:
$$T\_ave = \frac{1}{2} {\sum }_{n = 1}^{N} t\_int {( n )}^{2} / T\_ms$$

4. A radio communication system according to claim 1, wherein only when having received a beacon from an adjacent radio communication terminal close to a radio communication terminal comprising this unit, said radio communication unit transmits said data delivery path information to said adjacent radio communication terminal.

5. A radio communication system according to claim 1, wherein said radio communication unit transmits said data delivery path information when a reception interval of said beacons is at or above a predetermined interval and its transfer hop number or time that it has lasted is at or below a predetermined value and the average delivery delay time in a link is at or below a predetermined value.

6. A radio communication system according to claim 1, wherein said path information control unit further comprises data delivery path information updating means for updating said data delivery path information based on newly received data delivery path information when a time period of a predetermined update threshold length or longer has elapsed since the updating of said data delivery path information.
